(19) United States
(12) Patent Application Publication
(10) Pub. No.: US 2024/0132990 A1
(43) Pub. Date: Apr. 25, 2024

(54) METHOD AND SYSTEM FOR PERFORMING INTELLIGENT SORTING BASED ON DYNAMIC ADJUSTMENT OF THRESHOLD

(71) Applicant: HUZHOU HONEST INTELLIGENT TECHNOLOGY CO., LTD, Huzhou (CN)

(72) Inventors: Jin GUO, Beijing (CN); Xiaolei TONG, Beijing (CN)

(73) Assignee: HUZHOU HONEST INTELLIGENT TECHNOLOGY CO., LTD, Huzhou (CN)

(21) Appl. No.: 18/389,724

(22) Filed: Dec. 19, 2023

Related U.S. Application Data
(63) Continuation of application No. PCT/CN2022/104592, filed on Jul. 8, 2022.

(30) Foreign Application Priority Data
Jul. 8, 2021 (CN) 202110774603.7

(51) Int. Cl. C22B 1/24; B07C 5/36

(52) U.S. Cl. CPC C22B 1/24; B07C 5/361

(57) ABSTRACT

The present application relates to a method and system for performing intelligent sorting based on dynamic adjustment of a threshold. The method includes: sorting ores with a predetermined granularity by an intelligent sorting system according to a current grade threshold to output the sorted ores; performing grade detection on the fine ores to obtain a current state parameter of the fine ores; calculating a first error rate of a current comprehensive grade based on the current comprehensive grade and a target comprehensive grade, and in a case that the first error rate is not within a set range of a comprehensive error rate, calculating a dynamic adjustment step length for a grade threshold according to the current state parameter of the fine ores; and performing dynamic adjustment according to the dynamic adjustment step length and the current grade threshold to obtain the adjusted current grade threshold.

### CROSS-REFERENCE TO RELATED APPLICATIONS

The application claims priority to Chinese patent application No. 202110774603.7, filed on Jul. 8, 2021, the entire contents of which are incorporated herein by reference.

### TECHNICAL FIELD

The present invention belongs to the technical field of beneficiation, and in particular, relates to a method and system for performing intelligent sorting based on dynamic adjustment of a threshold.

### BACKGROUND

China has a large number of phosphate ore reserves, mostly concentrated in Yunnan, Hubei, Guizhou, Sichuan and Hunan provinces. Phosphate ores are concentrated, with fewer rich ores, more lean ores, fewer ores easy to beneficiate and more ores difficult to beneficiate. However, except for Yunnan and Guizhou regions, most of phosphate ores in China are medium and lean ores with a natural grade less than 27, so it is necessary to obtain one kind of phosphorus concentrate with the grade of 32 or 34 or more through a beneficiation process. However, phosphorite crystalline particles are extremely fine and impurities are embedded complicatedly, so obtaining high-grade phosphate concentrate has high requirement on the beneficiation process.

The conventional beneficiation method mainly includes: direct flotation, direct-reverse flotation, reverse flotation, double reverse flotation, heavy medium beneficiation, heavy medium-flotation combined beneficiation and the like. In the mature beneficiation technology of phosphorite ores, flotation is still a dominant sorting method. However, high energy consumption, high drug consumption and tailing water treatment of phosphate flotation make the cost of obtaining phosphate concentrate excessively high, and the problem of environmental unfriendliness is increasingly prominent. With the progress of science and technology in various industries, more and more novel beneficiation methods are used, and the X-ray sorting technology is also being tried and applied.

The principle of the X-ray sorting technology is: ore blocks are irradiated by X-rays, and data information of the attenuation intensity of X-rays after X-rays after passing through the are blocks is detected by a detector. The intensity information is related to the content of elements measured in the ore blocks. According to the detected data information, imaging treatment and analysis identification are performed, and the ore blocks are determined and marked according to a preset sorting parameter. Then, the ore blocks less than the threshold are discarded, while the ore blocks greater than or equal to the threshold are subjected to a next flotation treatment.

However, with the continuous dilution of the currently mined ores and different mining faces, even with the adoption of the X-ray sorting technology, the grade of raw ores entering a dressing plant still fluctuates greatly.

### SUMMARY

An objective of the present invention is to provide a beneficiation method based on intelligent sorting. The method of the present invention is suitable for sorting various types of ores, such as phosphorus ores and various metal ores. The method of the present invention is particularly suitable for the situation of obvious ore grade difference. The method provided by the present invention can keep the grade of fine ores entering a flotation system constant.

According to one aspect of the present invention, a method for performing intelligent sorting based on dynamic adjustment of a threshold is provided. The method includes:
Step 101: sorting ores with a predetermined granularity by an intelligent sorting system according to a current grade threshold to output the sorted ores;
Step 102: crushing the sorted ores outputted by the intelligent sorting system to obtain fine ores;
Step 103: performing grade detection on the fine ores to obtain a current state parameter of the fine ores, where the current state parameter includes a current comprehensive grade of the fine ores;
Step 104: calculating a first error rate of a current comprehensive grade based on the current comprehensive grade and a target comprehensive grade, and in a case that the first error rate is not within a set range of a comprehensive error rate, calculating a dynamic adjustment step length for a grade threshold according to the current state parameter of the fine ores; and
Step 105: performing dynamic adjustment according to the dynamic adjustment step length and the current grade threshold to obtain the adjusted current grade threshold, so that the intelligent sorting system sorts the ores with the predetermined granularity according to the adjusted current grade threshold.

Before sorting the ores with a predetermined granularity by an intelligent sorting system according to a current grade threshold, the method further includes: initially treating the to-be-treated original ores to obtain the ores with the predetermined granularity, and transmitting the ores with the predetermined granularity to the intelligent sorting system.

The sorting ores with a predetermined granularity by an intelligent sorting system according to a current grade threshold includes: acquiring the comprehensive grade of each ore with the predetermined granularity; determining the ores with the comprehensive grade less than the current grade threshold as waste ores, and discarding the waste ores; and determining the ores with the comprehensive grade equal to or greater than the current grade threshold as the sorted ores.

The crushing the sorted ores outputted by the intelligent sorting system includes: using a ball mill to crush the sorted ores outputted by the intelligent sorting system. The intelligent sorting system is an X-ray intelligent sorting machine. The initially treating the to-be-treated original ores to obtain the ores with the predetermined granularity includes: performing multi-level granularity treatment on the to-be-treated original ores to obtain the ores with the predetermined granularity, where each level of granularity treatment in the multi-level granularity treatment includes crushing treatment and sieving treatment, and the granularities of the ores obtained by each level of granularity treatment in the multi-level granularity treatment are sequentially reduced according to the treatment sequence of the granularity treatment from initialization to obtaining the ores with the predetermined granularity.

The performing multi-level granularity treatment on the to-be-treated original ores includes: performing crushing treatment in a first-level granularity treatment on the to-be-treated original ores, performing sieving treatment in the first-level granularity treatment on the ores subjected to the crushing treatment, transmitting the ores capable of passing the sieving treatment in the first-level granularity treatment to the second-level granularity treatment, and continuously performing crushing treatment in the first-level granularity treatment on the ores capable of not passing the sieving treatment in the first-level granularity treatment until being capable of passing the sieving treatment in the first-level granularity treatment: and according to the treatment sequence of the crushing treatment and the sieving treatment, from the second-level granularity treatment to the last level of granularity treatment of the multi-level granularity treatment, completing the initial treatment on the to-be-treated original ores to obtain the ores with the predetermined granularity.

The sorting ores with a predetermined granularity by an intelligent sorting system according to a current grade threshold to output the sorted ores includes: providing the ores with the predetermined granularity by a feeding subsystem to a high-speed belt of a transmission subsystem; after transmitting the ores with the predetermined granularity by the high-speed belt of the transmission subsystem for a predetermined distance, entering a stable state, and transmitting the ores with the predetermined granularity to a sensing subsystem; when the ores with the predetermined granularity are transmitted by the belt to pass through a part under a ray source of the sensing subsystem, using X-rays excited by a high voltage by the ray source to irradiate the ores with the predetermined granularity, the X-rays penetrating the ores with the predetermined granularity being attenuated to different degrees due to different contents of measured elements; collecting attenuation data information by a detector of the sensing subsystem located below the belt, converting the attenuation data information into a photoelectric digital signal, and transmitting the photoelectric digital signal to an intelligent identification subsystem of an intelligent identification system;
generating a to-be-identified image by the intelligent identification subsystem based on the photoelectric digital signal, performing content identification on the to-be-identified image to determine an ore parameter of the ores with the predetermined granularity, determining a current sorting parameter based on the current grade threshold, comparing the ore parameter with the current sorting parameter to mark the ores with the predetermined granularity as waste ores or high-grade ores based on a comparison result, and transmitting position information of ores marked as the high-grade ores to a blowing control unit of a separation subsystem; and
when the ores with the predetermined granularity are conveyed by the belt of the transmission subsystem to arrive at a predetermined position and a gas discharge gun of the separation subsystem is controlled by the blowing control unit, the ores with the predetermined granularity marked as the high-level ores or the waste ores are blown by a nozzle of the gas discharge gun so as to sort the waste ores and the high-level ores and sort the ores with the predetermined granularity to output the sorted ores.

After performing content identification on the to-be-identified image to determine an ore parameter of the ores with the predetermined granularity, the method further includes: determining the ores with the predetermined granularity of which the comprehensive grade is less than the current grade threshold as the waste ores, and determining the ores with the predetermined granularity of which the comprehensive grade is greater than or equal to the current grade threshold as the high-grade ores; acquiring a comprehensive grade value and quality of each waste ore entering the intelligent sorting system within a first predetermined time period, and acquiring a comprehensive grade value and quality of each high-grade ore entering the intelligent sorting system within the first predetermined time period;
based on the comprehensive grade value and quality of each waste ore, calculating a weighted average comprehensive grade

$$\\ Gf = \frac{{\sum }_{i = 1}^{nf} {kf}_{i} \times {mf}_{i}}{nf} ,$$

of the waste ores within the first predetermined time period,
where kfi is a comprehensive grade coefficient of an ith waste ore within the first predetermined time period, mfi is a quality coefficient of the ith waste ore within the first predetermined time period, and nf is a quantity of the waste ores within the first predetermined time period, and
based on the comprehensive grade value and quality of each high-grade ore, calculating a weighted average comprehensive grade

$$\\ Gy = \frac{{\sum }_{i = 1}^{ny} {ky}_{i} \times {my}_{i}}{ny} ,$$

of the high-grade ores within the first predetermined time period,
where kyi is a comprehensive grade coefficient of an ith high-grade ore within the first predetermined time period, myi is a quality coefficient of the ith high-grade ore within the first predetermined time period, and ny is a quantity of the waste ores within the first predetermined time period.

The crushing the sorted ores outputted by the intelligent sorting system to obtain fine ores includes: determining the granularity of the sorted ores outputted by the intelligent sorting system: in a case that the granularity is greater than a ball-milling threshold, crushing ores with the granularity greater than the ball-milling threshold until the granularity is less than or equal to the ball-milling threshold; and in a case that the granularity is less than the ball-milling threshold, crushing the ores with the granularity less than the ball-milling threshold by a ball mill to obtain the fine ores. The performing grade detection on the fine ores to obtain a current state parameter of the fine ores includes: within a second predetermined time period, using each mechanical arm of a plurality of mechanical arms to obtain fine ores with the predetermined quality from the belt conveying the fine ores according to a predetermined time interval; promoting each mechanical arm to convey the obtained fine ores with the predetermined quality to an aggregate position of a fluorescence analyzer through a negative-pressure pipeline; and when the quality of the fine ores at the aggregate position reaches a quality threshold, promoting the fluorescence analyzer to perform grade detection on the fine ores to obtain the current state parameter of the fine ores, where the current state parameter includes a current comprehensive grade of the fine ores, a primary element grade of the fine ores, a secondary element grade of the fine ores and a waste ore grade of the fine ores.

The method further includes: accumulating a running position of a device in the intelligent sorting system, a belt transfer state, a crushing statistical time, a sieving statistical time, a ball-milling statistical time and an analysis statistical time to determine a system delay time; based on the weighted comprehensive average grade related to the waste ores and/or the high-grade ores sorted by the intelligent sorting system within the range of the system delay time and grade analysis data of the fine ores acquired by a fluorescence monitor, determining a second error rate of a fine ore grade to a target grade at a specific time; in a case that the fine ore grade at the specific time is less than the target grade and the second error rate is greater than a set range of an error rate, determining a step length function based on the second error rate and a plurality of step lengths are determined through the step length function, and increasing the step length by taking a predetermined time interval as the current grade threshold; and in a case that the fine ore grade at the specific time is greater than the target grade and the second error rate is greater than the set range of the error rate, determining the step length function based on the second error rate and determining the plurality of step lengths through the step length function, and reducing the step length by taking the predetermined time interval as the current grade threshold. In a case that the first error rate is within a set range of the comprehensive error rate, waiting for a third predetermined time period, and performing Step 101 in a case that the third predetermined time period expires. The method further includes: determining a data matching time period, where the data matching time period is, for the same batch of ores with the predetermined granularity, a time difference value between a time T1 when the ores with the predetermined granularity are sorted by the intelligent sorting system according to the current grade threshold and a time T2 when the fine ores are subjected to grade detection to obtain the current state parameter of the fine ores.

The calculating a dynamic adjustment step length for a grade threshold according to the current state parameter of the fine ores includes:
a step length N=f(x1,x2,x3,x4,x5,x6,x7),
where x1 is an error of a primary element grade and a primary element target grade, x2 is an error of a first secondary element grade and a first secondary element target grade, x3 is an error of a second secondary element grade and a second secondary element target grade, x4 is the weighted comprehensive grade of the high-grade ores at a current time, x5 is the weighted average comprehensive grade of the waste ores at the current time, x6 is a quantity proportion of the high-grade ores, x7 is the current grade threshold,
x1 is a main parameter and is used with x2 and x3 in an exponential relationship, and x4, x5, x6 and x7 construct a fitting point through a fitting function to map a point obtained through comprehensive calculation of x1, x2 and x3 on the fitting point to finally obtain a step length N.

The performing dynamic adjustment according to the dynamic adjustment step length and the current grade threshold to obtain the adjusted current grade threshold, so that the intelligent sorting system sorts the ores with the predetermined granularity according to the adjusted current grade threshold includes: in a case that the current comprehensive grade is less than the target comprehensive grade, adding the current grade threshold and the dynamic adjustment step length to serve as an adjusted current grade threshold, taking the adjusted current grade threshold as the current grade threshold, and performing Step 101; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, and performing Step 101. The performing dynamic adjustment according to the dynamic adjustment step length and the current grade threshold to obtain the adjusted current grade threshold, so that the intelligent sorting system sorts the ores with the predetermined granularity according to the adjusted current grade threshold includes: in a case that the current comprehensive grade is less than the target comprehensive grade, adding the current grade threshold and the dynamic adjustment step length to serve as an adjusted current grade threshold, taking the adjusted current grade threshold as the current grade threshold, performing Step 101, and waiting for a fourth predetermined time period after completing Step 102; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, performing Step 101, and waiting for the fourth predetermined time period after completing Step 102, where the fourth predetermined time period is greater than the data matching time period. The intelligent sorting system, the ball mill and the fluorescence on-line analyzer adopt closed-loop control.

According to another aspect of the present invention, a system for performing intelligent sorting based on dynamic adjustment of a threshold is provided. The system includes: a sorting device, configured to promote to sort ores with a predetermined granularity by an intelligent sorting system according to a current grade threshold to output the sorted ores; a crushing device, configured to crush the sorted ores outputted by the intelligent sorting system to obtain fine ores; a detection device, configured to perform grade detection on the fine ores to obtain a current state parameter of the fine ores, where the current state parameter includes a current comprehensive grade of the current fine ores; a calculation device, configured to: calculate a first error rate of a current comprehensive grade based on the current comprehensive grade and a target comprehensive grade, and in a case that the first error rate is not within a set range of a comprehensive error rate, calculate a dynamic adjustment step length of a grade threshold according to the current state parameter of the fine ores; and an adjusting device, configured to perform dynamic adjustment according to the dynamic adjustment step length and the current grade threshold to obtain the adjusted current grade threshold, so that the intelligent sorting system sorts the ores with the predetermined granularity according to the adjusted current grade threshold.

The system further includes an initializing device, configured to initially treat the to-be-treated original ores to obtain the ores with the predetermined granularity, and transmit the ores with the predetermined granularity to the intelligent sorting system. The sorting device sorts ores with a predetermined granularity by an intelligent sorting system according to a current grade threshold, which includes: the sorting device obtains a comprehensive grade of each ore with the predetermined granularity; the sorting device determines the ores with the comprehensive grade less than the current grade threshold as waste ores, and discards the waste ores: and the sorting device determines the ores with the comprehensive grade equal to or greater than the current grade threshold as the sorted ores. The crushing device crushes the sorted ores outputted by the intelligent sorting system, which includes: the crushing device uses a ball mill to crush the sorted ores outputted by the intelligent sorting system. The intelligent sorting system is an X-ray intelligent sorting machine. The initializing device initially treats the to-be-treated original ores to obtain the ores with the predetermined granularity, which includes: the initializing device performs multi-level granularity treatment on the to-be-treated original ores to obtain the ores with the predetermined granularity, where each level of granularity treatment in the multi-level granularity treatment includes crushing treatment and sieving treatment, and the granularities of the ores obtained by each level of granularity treatment in the multi-level granularity treatment are sequentially reduced according to the treatment sequence of the granularity treatment from initialization to obtaining the ores with the predetermined granularity.

The initializing device performs multi-level granularity treatment on the to-be-treated original ores, which includes: the initializing device performs crushing treatment in a first-level granularity treatment on the to-be-treated original ores, performs sieving treatment in the first-level granularity treatment on the ores subjected to the crushing treatment, transmits the ores capable of passing the sieving treatment in the first-level granularity treatment to the second-level granularity treatment, and continuously performs crushing treatment in the first-level granularity treatment on the ores capable of not passing the sieving treatment in the first-level granularity treatment until being capable of passing the sieving treatment in the first-level granularity treatment; and the initializing device, according to the treatment sequence of the crushing treatment and the sieving treatment, from the second-level granularity treatment to the last level of granularity treatment of the multi-level granularity treatment, completes the initial treatment on the to-be-treated original ores to obtain the ores with the predetermined granularity. The sorting device sorts ores with a predetermined granularity by an intelligent sorting system according to a current grade threshold to output the sorted ores, which includes: the sorting device provides the ores with the predetermined granularity by a feeding subsystem to a high-speed belt of a transmission subsystem; after transmitting the ores with the predetermined granularity by the high-speed belt of the transmission subsystem for a predetermined distance, the sorting device enters a stable state, and transmits the ores with the predetermined granularity to a sensing subsystem; when the ores with the predetermined granularity are transmitted by the belt to pass through a part under a ray source of the sensing subsystem, the ray source uses X-rays excited by a high voltage to irradiate the ores with the predetermined granularity, where the X-rays penetrating the ores with the predetermined granularity are attenuated to different degrees due to different contents of measured elements; attenuation data information is collected by a detector of the sensing subsystem located below the belt, the attenuation data information is converted into a photoelectric digital signal, and the photoelectric digital signal is transmitted to an intelligent identification subsystem of an intelligent identification system; the intelligent identification subsystem generates a to-be-identified image based on the photoelectric digital signal, performs content identification on the to-be-identified image to determine an ore parameter of the ores with the predetermined granularity, determines a current sorting parameter based on the current grade threshold, compares the ore parameter with the current sorting parameter to mark the ores with the predetermined granularity as waste ores or high-grade ores based on a comparison result, and transmits position information of ores marked as the high-grade ores to a blowing control unit of a separation subsystem; and
when the ores with the predetermined granularity are conveyed by the belt of the transmission subsystem to arrive at a predetermined position and a gas discharge gun of the separation subsystem is controlled by the blowing control unit, the ores with the predetermined granularity marked as the high-level ores or the waste ores are blown by a nozzle of the gas discharge gun so as to sort the waste ores and the high-level ores and sort the ores with the predetermined granularity to output the sorted ores.

After the intelligent identification subsystem performs content identification on the to-be-identified image to determine an ore parameter of the ores with the predetermined granularity, the system further includes: the ores with the predetermined granularity of which the comprehensive grade is less than the current grade threshold are determined as the waste ores, and the ores with the predetermined granularity of which the comprehensive grade is greater than or equal to the current grade threshold are determined as the high-grade ores; a comprehensive grade value and quality of each waste ore entering the intelligent sorting system are acquired within a first predetermined time period, and a comprehensive grade value and quality of each high-grade ore entering the intelligent sorting system are acquired within the first predetermined time period;
based on the comprehensive grade value and quality of each waste ore, a weighted average grade

$$\\ Gf = \frac{{\sum }_{i = 1}^{nf} {kf}_{i} \times {mf}_{i}}{nf} ,$$

of the waste ores is calculated within the first predetermined time period,
where kfi is a comprehensive grade coefficient of an ith waste ore within the first predetermined time period, mfi is a quality coefficient of the ith waste ore within the first predetermined time period, and nf is a quantity of the waste ores within the first predetermined time period; and
based on the comprehensive grade value and quality of each high-grade ore, a weighted average comprehensive grade

$$\\ Gy = \frac{{\sum }_{i = 1}^{ny} {ky}_{i} \times {my}_{i}}{ny} ,$$

of the high-grade ores is calculated within the first predetermined time period,
where kyi is a comprehensive grade coefficient of an ith high-grade ore within the first predetermined time period, myi is a quality coefficient of the ith high-grade ore within the first predetermined time period, and ny is a quantity of the waste ores within the first predetermined time period.

The crushing device crushes the sorted ores outputted by the intelligent sorting system to obtain fine ores, which includes: the crushing device determines the granularity of the sorted ores outputted by the intelligent sorting system: in a case that the granularity is greater than a ball-milling threshold, ores with the granularity greater than the ball-milling threshold are crushed until the granularity is less than or equal to the ball-milling threshold; and in a case that the granularity is less than the ball-milling threshold, the crushing device uses a ball mill to crush the ores with the granularity less than the ball-milling threshold to obtain the fine ores. The detection device performs grade detection on the fine ores to obtain a current state parameter of the fine ores, which includes:
the detection device, within a second predetermined time period, uses each mechanical arm of a plurality of mechanical arms to obtain fine ores with the predetermined quality from the belt conveying the fine ores according to a predetermined time interval; the detection device promotes each mechanical arm to convey the obtained fine ores with the predetermined quality to an aggregate position of a fluorescence analyzer through a negative-pressure pipeline; and when the quality of the fine ores at the aggregate position reaches a quality threshold, the detection device promotes the fluorescence analyzer to perform grade detection on the fine ores to obtain the current state parameter of the fine ores, where the current state parameter includes a current comprehensive grade of the fine ores, a primary element grade of the fine ores, a secondary element grade of the fine ores and a waste ore grade of the fine ores. The system further includes: a running position of a device in the intelligent sorting system, a belt transfer state, a crushing statistical time, a sieving statistical time, a ball-milling statistical time and an analysis statistical time are accumulated to determine a system delay time; based on the weighted comprehensive average grade related to the waste ores and/or the high-grade ores sorted by the intelligent sorting system within the range of the system delay time and grade analysis data of the fine ores acquired by a fluorescence monitor, a second error rate of a fine ore grade to a target grade at a specific time is determined; in a case that the fine ore grade at the specific time is less than the target grade and the second error rate is greater than a set range of an error rate, a step length function based on the second error rate is determined and a plurality of step lengths are determined through the step length function, and the step length is increased by taking a predetermined time interval as the current grade threshold; and in a case that the fine ore grade at the specific time is greater than the target grade and the second error rate is greater than the set range of the error rate, the step length function based on the second error rate is determined and the plurality of step lengths through the step length function are determined, and the step length is reduced by taking the predetermined time interval as the current grade threshold.

In a case that the first error rate is within a set range of the comprehensive error rate, a third predetermined time period is waited, and in a case that the third predetermined time period expires, the intelligent sorting system is promoted to sort the ores with the predetermined granularity according to the current grade threshold. The system further includes: a data matching time period is determined, where the data matching time period is, for the same batch of ores with the predetermined granularity, a time difference value between a time T1 when the ores with the predetermined granularity are sorted by the intelligent sorting system according to the current grade threshold and a time T2 when the fine ores are subjected to grade detection to obtain the current state parameter of the fine ores. The step that a dynamic adjustment step length of a grade threshold is calculated according to the current state parameter of the fine ores includes:
a step length N=f(x1,x2,x3,x4,x5,x6,x7),
where x1 is an error of a primary element grade and a primary element target grade, x2 is an error of a first secondary element grade and a first secondary element target grade, x3 is an error of a second secondary element grade and a second secondary element target grade, x4 is the weighted comprehensive grade of the high-grade ores at a current time, x5 is the weighted average comprehensive grade of the waste ores at the current time, x6 is a quantity proportion of the high-grade ores, x7 is the current grade threshold,
x1 is a main parameter and is used with x2 and x3 in an exponential relationship, and x4, x5, x6 and x7 construct a fitting point through a fitting function to map a point obtained through comprehensive calculation of x, x2 and x3 on the fitting point to finally obtain a step length N.

The performing dynamic adjustment according to the dynamic adjustment step length and the current grade threshold to obtain the adjusted current grade threshold, so that the intelligent sorting system sorts the ores with the predetermined granularity according to the adjusted current grade threshold includes: in a case that the current grade threshold is less than the target comprehensive grade, adding the current grade threshold and the dynamic adjustment step length to serve as an adjusted current grade threshold, taking the adjusted current grade threshold as the current grade threshold, and promoting the intelligent sorting system to sort the ores with the predetermined granularity according to the current grade threshold; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, and promoting the intelligent sorting system to sort the ores with the predetermined granularity according to the current grade threshold. The performing dynamic adjustment according to the dynamic adjustment step length and the current grade threshold to obtain the adjusted current grade threshold, so that the intelligent sorting system sorts the ores with the predetermined granularity according to the adjusted current grade threshold includes: in a case that the current grade threshold is less than the target comprehensive grade, adding the current grade threshold and the dynamic adjustment step length to serve as an adjusted current grade threshold, taking the adjusted current grade threshold as the current grade threshold, promoting to use the intelligent sorting system to sort the ores with the predetermined granularity according to the current grade threshold, and after crushing the sorted ores outputted by the intelligent sorting system to obtain fine ores, waiting for a fourth predetermined time period; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, promoting to use the intelligent sorting system to sort the ores with the predetermined granularity according to the current grade threshold, and after crushing the sorted ores outputted by the intelligent sorting system to obtain fine ores, waiting for the fourth predetermined time period, where the fourth predetermined time period is greater than the data matching time period.

According to yet another aspect of the present invention, a computer-readable storage medium is provided, where the storage medium stores a computer program, and the computer program is configured to perform the method according to any one of the above.

According to still another aspect of the present invention, an electronic device is provided. The electronic device includes: a processor; a memory, configured to store an executable instruction of the processor, where the processor is configured to read the executable instruction from the memory and execute the instruction to implement the method according to any one of the above.

According to still another aspect of the present invention, a concentrate beneficiation method based on intelligent sorting is provided. The method includes: Step 201: after sieving and grading raw ores, conveying ores conforming to a standard granularity into an intelligent sorting system; Step 202: discarding ores with an excessively low grade by the intelligent sorting system according to a set comprehensive grade threshold T1, and transmitting a calculation parameter related to the comprehensive grade threshold T1 to a central control system; Step 203: transmitting concentrate sorted by the intelligent sorting system to a ball mill for crushing; Step 204: performing grade detection on fine ores obtained through crushing of the ball mill, and transmitting a detection result to the central control system; and Step 205: after obtaining the detection result of the concentrate grade, determining a current grade according to the detection result, and adjusting a calculation parameter related to the comprehensive grade threshold T1 according to the current grade so as to adjust the comprehensive grade threshold T1. The intelligent sorting system in Step 202 is an X-ray intelligent sorting machine, including a sensing system, an intelligent identification system and a separation system. The X-ray intelligent sorting machine uses a separation system to separate waste ore blocks and high-grade ores according to a photoelectric digital signal converted by different degrees of attenuation intensity data information generated when X-rays penetrate through the ores. The sieving and grading in Step 201 are realized through crushing and sieving cycle control treatment, including multiple rounds of crushing and sieving cycle control treatment. Phosphorus concentrate before entering the ball mill in Step 203 is subjected to crushing and sieving cycle control treatment. The grade parameter of the fine ores is monitored by a fluorescence analyzer on line and in real time. On a fine ore belt obtained by the ball mill, a certain number of fine ores are sucked through the negative-pressure pipeline and conveyed to the fluorescence analyzer, and the fluorescence analyzer automatically analyzes the grade of the fine ores and uploads the analyzed data to a central control system. The central control system is configured to receive comprehensive grade data information in real time and feed the comprehensive grade data information back to a sorting system to adjust a comprehensive ore grade threshold. The intelligent sorting system, the ball mill, the fluorescence on-line analyzer and the central control system adopt closed-loop control. The feeding system is a vibrating feeder. The sorting system is configured to detect the grade of the ores through X-rays and use a separation system to separate waste ore blocks and high-grade ores. The X-ray intelligent sorting machine collects attenuation information data of ores under X-rays, cooperates with the fluorescence analyzer to perform real-time grade analysis and performs feedback to the central control system, and the attenuation information data and the real-time grade analysis are trained by a self-learning model, so that the sorting system has a grade prediction ability. The fluorescence on-line analyzer performs on-line detection on the fine ores obtained by the ball mill.

An on-line detection method of the present application is: arranging a plurality of mechanical arm positions on a fine ore belt obtained by the ball mill, automatically sucking a certain number of fine ores by the mechanical arms, conveying the fine ores to an aggregate position of a fluorescence analyzer through a negative-pressure pipeline, then performing automatic analysis, analyzing the grade of phosphorus, and then uploading the analyzed data to a central control system. According to the phosphorus concentrate beneficiation process provided by the present invention, the phosphate ores are intelligently pre-sorted through a closed-loop control route of the sorting system, the ball mill, the fluorescence on-line analyzer and the central control system, thereby effectively controlling the grade of floating phosphate ores within a stable mean value range and improving the grade of the ores. Meanwhile, unmanned mechanic operation can be realized, the working efficiency is high, and the economic and human costs are greatly reduced.

### BRIEF DESCRIPTION OF DRAWINGS

The exemplary embodiments of the present invention may be understood more completely with reference to the following accompanying drawings:

FIG. 1 is a flowchart of a method for performing intelligent sorting based on dynamic adjustment of a threshold according to an embodiment of the present invention;

FIG. 2 is a flowchart of a method for performing intelligent sorting based on dynamic adjustment of a threshold according to another embodiment of the present invention;

FIG. 3 is a flowchart of a method for dynamically adjusting a threshold according to another embodiment of the present invention;

FIG. 4 is a schematic structural diagram of an intelligent sorting system according to an embodiment of the present invention; and

FIG. 5 is a schematic structural diagram of a system for performing intelligent sorting based on dynamic adjustment of a threshold according to an embodiment of the present invention.

### DETAILED DESCRIPTION OF THE EMBODIMENTS

The present invention is further described below with reference to the accompanying drawings.

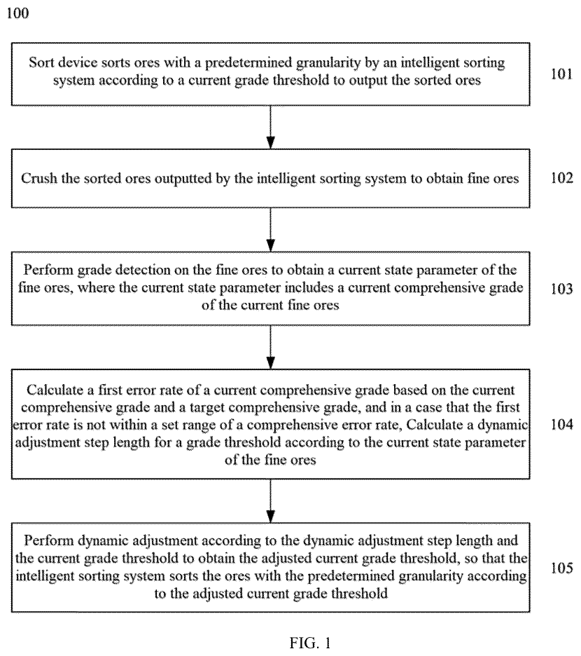

FIG. 1 is a flowchart of a method 100 for performing intelligent sorting based on dynamic adjustment of a threshold according to an embodiment of the present invention. The method 100 starts from Step 101.

Step 101: ores with a predetermined granularity are sorted by an intelligent sorting system according to a current grade threshold to output the sorted ores. When an X-ray sorting technology is used, it is necessary to dissociate raw ores to a certain fine granularity before sorting. For the phosphate ores, generally, the raw ores are crushed to below at least 45 mm. Therefore, before sorting the ores with a predetermined granularity by an intelligent sorting system according to a current grade threshold, the method further includes: the to-be-treated original ores are initially treated to obtain the ores with the predetermined granularity, and the ores with the predetermined granularity are determined to the intelligent sorting system.

The step that the ores with a predetermined granularity are sorted by an intelligent sorting system according to a current grade threshold includes: the comprehensive grade of each ore with the predetermined granularity is acquired; the ores with the comprehensive grade less than the current grade threshold are determined as waste ores, and the waste ores are discarded; and the ores with the comprehensive grade equal to or greater than the current grade threshold are determined as the sorted ores.

The step that the to-be-treated original ores are initially treated to obtain the ores with the predetermined granularity includes: multi-level granularity treatment is performed on the to-be-treated original ores to obtain the ores with the predetermined granularity, where each level of granularity treatment in the multi-level granularity treatment includes crushing treatment and sieving treatment, and the granularities of the ores obtained by each level of granularity treatment in the multi-level granularity treatment are sequentially reduced according to the treatment sequence of the granularity treatment from initialization to obtaining the ores with the predetermined granularity.

The step that multi-level granularity treatment is performed on the to-be-treated original ores includes: crushing treatment in a first-level granularity treatment is performed on the to-be-treated original ores, sieving treatment in the first-level granularity treatment is performed on the ores subjected to the crushing treatment, the ores capable of passing the sieving treatment in the first-level granularity treatment are transmitted to the second-level granularity treatment, and crushing treatment in the first-level granularity treatment is continuously performed on the ores capable of not passing the sieving treatment in the first-level granularity treatment until being capable of passing the sieving treatment in the first-level granularity treatment; and according to the treatment sequence of the crushing treatment and the sieving treatment, from the second-level granularity treatment to the last level of granularity treatment of the multi-level granularity treatment, the initial treatment on the to-be-treated original ores is completed to obtain the ores with the predetermined granularity.

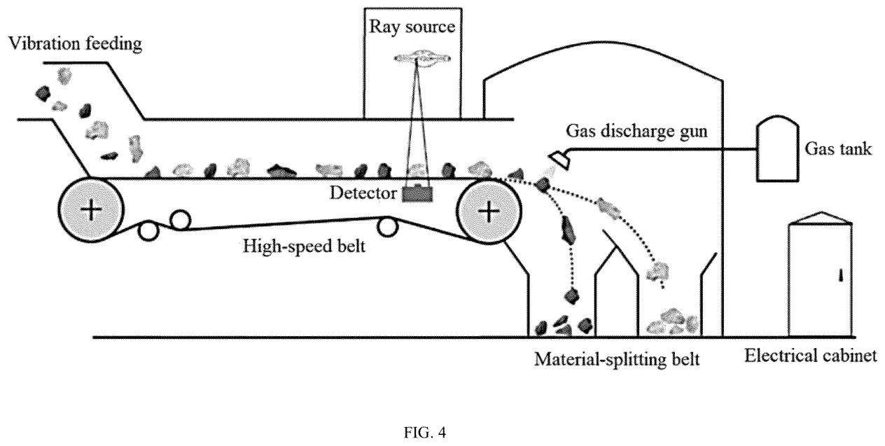

FIG. 4 is a schematic structural diagram of an intelligent sorting system according to an embodiment of the present invention. As shown in FIG. 4, the step that ores with a predetermined granularity are sorted by an intelligent sorting system according to a current grade threshold to output the sorted ores includes: the ores with the predetermined granularity are provided by a feeding subsystem to a high-speed belt of a transmission subsystem; after transmitting the ores with the predetermined granularity for a predetermined distance, the high-speed belt of the transmission subsystem enters a stable state, and transmits the ores with the predetermined granularity to a sensing subsystem; when the ores with the predetermined granularity are transmitted by the belt to pass through a part under a ray source of the sensing subsystem, the ray source uses X-rays excited by a high voltage to irradiate the ores with the predetermined granularity, where the X-rays penetrating the ores with the predetermined granularity are attenuated to different degrees due to different contents of measured elements; attenuation data information is collected by a detector of the sensing subsystem located below the belt, the attenuation data information is converted into a photoelectric digital signal, and the photoelectric digital signal is transmitted to an intelligent identification subsystem of an intelligent identification system; the intelligent identification subsystem generates a to-be-identified image based on the photoelectric digital signal, performs content identification on the to-be-identified image to determine an ore parameter of the ores with the predetermined granularity, determines a current sorting parameter based on the current grade threshold, compares the ore parameter with the current sorting parameter to mark the ores with the predetermined granularity as waste ores or high-grade ores based on a comparison result, and transmits position information of ores marked as the high-grade ores to a blowing control unit of a separation subsystem; and when the ores with the predetermined granularity are conveyed by the belt of the transmission subsystem to arrive at a predetermined position and a gas discharge gun of the separation subsystem is controlled by the blowing control unit, the ores with the predetermined granularity marked as the high-level ores or the waste ores are blown by a nozzle of the gas discharge gun so as to sort the waste ores and the high-level ores and sort the ores with the predetermined granularity to output the sorted ores.

After the step that content identification is performed on a to-be-identified image to determine the ore parameter of the ores with the predetermined granularity, the method further includes:
the ores with the predetermined granularity of which the comprehensive grade is less than the current grade threshold are determined as the waste ores, and the ores with the predetermined granularity of which the comprehensive grade is greater than or equal to the current grade threshold are determined as the high-grade ores;
a comprehensive grade value and quality of each waste ore entering the intelligent sorting system within a first predetermined time period are acquired, and a comprehensive grade value and quality of each high-grade ore entering the intelligent sorting system within the first predetermined time period are acquired;
based on the comprehensive grade value and quality of each waste ore, a weighted average comprehensive grade

$$\\ Gf = \frac{{\sum }_{i = 1}^{nf} {kf}_{i} \times {mf}_{i}}{nf} ,$$

of the waste ores within the first predetermined time period is calculated,
where kfi is a comprehensive grade coefficient of an ith waste ore within the first predetermined time period, mfi is a quality coefficient of the ith waste ore within the first predetermined time period, and nf is a quantity of the waste ores within the first predetermined time period; and
based on the comprehensive grade value and quality of each high-grade ore, a weighted average comprehensive grade

$$\\ Gy = \frac{{\sum }_{i = 1}^{ny} {ky}_{i} \times {my}_{i}}{ny} ,$$

of the high-grade ores within the first predetermined time period is calculated,
where kyi is a comprehensive grade coefficient of an ith high-grade ore within the first predetermined time period, myi is a quality coefficient of the ith high-grade ore within the first predetermined time period, and ny is a quantity of the waste ores within the first predetermined time period.

The acquired weighted average comprehensive grade of the waste ores within the first predetermined time period and the weighted average comprehensive grade of the high-grade ores within the first predetermined time period can provide basic data for the calculation of the dynamic adjustment step length, so that the calculation of the dynamic adjustment step length is more scientific and reasonable, thereby effectively controlling the grade of floating phosphate ores within a stable mean value range and improving the grade of the ores.

Step 102: the sorted ores outputted by the intelligent sorting system are crushed to obtain fine ores; The step that the sorted ores outputted by the intelligent sorting system are crushed by the intelligent sorting system includes: the ball mill is used to crush the sorted ores outputted by the intelligent sorting system. The intelligent sorting system is an X-ray intelligent sorting machine.

The step that the sorted ores outputted by the intelligent sorting system are crushed to obtain fine ores includes: the granularity of the sorted ores outputted by the intelligent sorting system is determined: in a case that the granularity is greater than a ball-milling threshold, ores with the granularity greater than the ball-milling threshold are crushed until the granularity is less than or equal to the ball-milling threshold; and in a case that the granularity is less than the ball-milling threshold, the ores with the granularity less than the ball-milling threshold by a ball mill are crushed to obtain the fine ores.

Step 103: grade detection is performed on the fine ores to obtain a current state parameter of the fine ores, where the current state parameter includes a current comprehensive grade of the fine ores; the step that grade detection is performed on the fine ores to obtain a current state parameter of the fine ores includes: within a second predetermined time period, each mechanical arm of a plurality of mechanical arms is used to obtain fine ores with the predetermined quality from the belt conveying the fine ores according to a predetermined time interval; each mechanical arm is promoted to convey the obtained fine ores with the predetermined quality to an aggregate position of a fluorescence analyzer through a negative-pressure pipeline; and when the quality of the fine ores at the aggregate position reaches a quality threshold, the fluorescence analyzer is promoted to perform grade detection on the fine ores to obtain the current state parameter of the fine ores, where the current state parameter includes a current comprehensive grade of the fine ores, a primary element grade of the fine ores, a secondary element grade of the fine ores and a waste ore grade of the fine ores. The fine ores are obtained through interval sampling and grade detection is performed on the fine ores, and the current state parameter of the fine ores conforms to the actual grade of the fine ores within the second predetermined time period, so that the calculation of the dynamic adjustment step length is more scientific and reasonable, thereby effectively controlling the grade of floating phosphate ores within a stable mean value range and improving the grade of the ores. The method further includes: a running position of a device in the intelligent sorting system, a belt transfer state, a crushing statistical time, a sieving statistical time, a ball-milling statistical time and an analysis statistical time are accumulated to determine a system delay time; based on the weighted comprehensive average grade related to the waste ores and/or the high-grade ores sorted by the intelligent sorting system within the range of the system delay time and grade analysis data of the fine ores acquired by a fluorescence monitor, a second error rate of a fine ore grade to a target grade at a specific time is determined; in a case that the fine ore grade at the specific time is less than the target grade and the second error rate is greater than a set range of an error rate, a step length function is determined based on the second error rate and a plurality of step lengths are determined through the step length function, and the step length is increased by taking a predetermined time interval as the current grade threshold; and in a case that the fine ore grade at the specific time is greater than the target grade and the second error rate is greater than the set range of the error rate, the step length function is determined based on the second error rate and the plurality of step lengths are determined through the step length function, and the step length is reduced by taking the predetermined time interval as the current grade threshold.

Step 104: a first error rate of a current comprehensive grade is calculated based on the current comprehensive grade and a target comprehensive grade, and in a case that the first error rate is not within a set range of a comprehensive error rate, a dynamic adjustment step length for a grade threshold is calculated according to the current state parameter of the fine ores; and
in a case that the first error rate is within a set range of the comprehensive error rate, a third predetermined time period, is waited and Step 101 is performed in a case that the third predetermined time period expires.

The method further includes: a data matching time period is determined, where the data matching time period is, for the same batch of ores with the predetermined granularity, a time difference value between a time T1 when the ores with the predetermined granularity are sorted by the intelligent sorting system according to the current grade threshold and a time T2 when the fine ores are subjected to grade detection to obtain the current state parameter of the fine ores.

The step that a dynamic adjustment step length for a grade threshold is calculated according to the current state parameter of the fine ores includes:
a step length N=f(x1,x2,x3,x4,x5,x6,x7),
where x1 is an error of a primary element grade and a primary element target grade, x2 is an error of a first secondary element grade and a first secondary element target grade, x3 is an error of a second secondary element grade and a second secondary element target grade, x4 is the weighted comprehensive grade of the high-grade ores at a current time, x5 is the weighted average comprehensive grade of the waste ores at the current time, x6 is a quantity proportion of the high-grade ores, x7 is the current grade threshold,
x1 is a main parameter and is used with x2 and x3 in an exponential relationship, and
x4, x5, x6 and x7 construct a fitting point through a fitting function to map a point obtained through comprehensive calculation of x1, x2 and x3 on the fitting point to finally obtain a step length N.

Step 105: dynamic adjustment is performed according to the dynamic adjustment step length and the current grade threshold to obtain the adjusted current grade threshold, so that the intelligent sorting system sorts the ores with the predetermined granularity according to the adjusted current grade threshold.

The step that dynamic adjustment is performed according to the dynamic adjustment step length and the current grade threshold to obtain the adjusted current grade threshold, so that the intelligent sorting system sorts the ores with the predetermined granularity according to the adjusted current grade The process includes:
in a case that the current comprehensive grade is less than the target comprehensive grade, the current grade threshold and the dynamic adjustment step length are added to serve as an adjusted current grade threshold, the adjusted current grade threshold serves as the current grade threshold, and Step 101 is performed; in a case that the current comprehensive grade is greater than the target comprehensive grade, the dynamic adjustment step length is subtracted from the current grade threshold to serve as an adjusted current grade threshold, the adjusted current grade threshold serves as the current grade threshold, and Step 101 is performed.

The step that dynamic adjustment is performed according to the dynamic adjustment step length and the current grade threshold to obtain the adjusted current grade threshold, so that the intelligent sorting system sorts the ores with the predetermined granularity according to the adjusted current grade The process includes:
in a case that the current comprehensive grade is less than the target comprehensive grade, the current grade threshold and the dynamic adjustment step length are added to serve as an adjusted current grade threshold, the adjusted current grade threshold serves as the current grade threshold, Step 101 is performed, and a fourth predetermined time period is waited after Step 102 is completed; and in a case that the current comprehensive grade is greater than the target comprehensive grade, the dynamic adjustment step length is subtracted from the current grade threshold to serve as an adjusted current grade threshold, the adjusted current grade threshold serves as the current grade threshold, Step 101 is performed, and the fourth predetermined time period is waited after Step 102 is completed, where the fourth predetermined time period is greater than the data matching time period. By setting the above time length, the execution time of the current grade threshold is greater than the data matching time period, thereby avoiding the influence of different grade thresholds on the sorting method. The intelligent sorting system, the ball mill and the fluorescence on-line analyzer adopt closed-loop control.

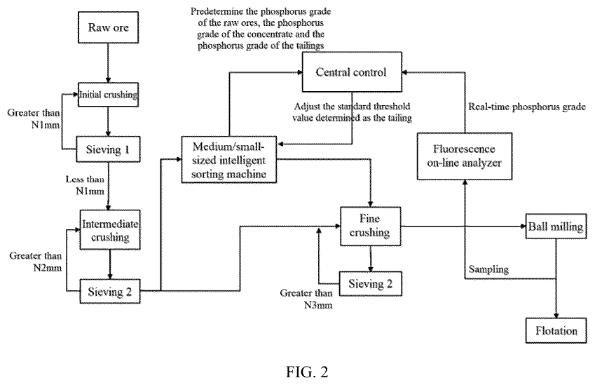

According to the method for performing intelligent sorting based on dynamic adjustment of a threshold, the grade threshold is dynamically adjusted based on the related error rate of the current comprehensive grade to the target comprehensive grade, the intelligent sorting system sorts the ores with the predetermined granularity according to the adjusted current grade threshold, so that the grade of the sorted ores within a certain time period is dynamically adjusted according to requirements, thereby effectively controlling the grade of floating phosphate ores within a stable mean value range and improving the grade of the ores. Meanwhile, unmanned mechanic operation can be realized, the working efficiency is high, and the economic and human costs are greatly reduced. FIG. 2 is a flowchart of a method for performing intelligent sorting based on dynamic adjustment of a threshold according to another embodiment of the present invention. The following description takes phosphate ores as an example. It should be understood that the present application is not limited to the phosphate ores, but may be suitable for various ores.

In the first step, raw ores are sieved and graded, and after sieving and grading are realized through crushing and sieving cycle control, ores with a proper standard granularity are transmitted by a feeding system to enter a sorting system.

The crushing and sieving cycle control is specifically as follows: the raw ores are thrown into a crushing machine for crushing, and the crushed ores enter a sieving system. As an example, the sieving system may be a vibrating sieve, including two layers of sieve meshes, where a pore diameter of the first layer of sieve mesh is greater than that of the second layer of sieve mesh. For example, the granularity of the ores is 10-30 mm, then the pore diameter of the first layer of sieve mesh is 30 mm and the pore diameter of the second layer of sieve mesh is 10 mm. In the process, all the ores will be dumped on the first layer of sieve mesh; and through vibration, the ores with the granularity less than 30 will fall on the second layer of sieve mesh, and the ores with the granularity greater than 30 mm will enter a special transfer belt along with the vibration and is continuously transported to the crushing machine for cyclic crushing again. In the ores falling on the second layer of sieve mesh, along with vibration, the ores with the granularity less than 10 mm will fall on a fine ore belt and will be transferred to a fine ore collection bin, and the ores with the granularity of 10-30 mm reserved on the second layer of sieve mesh enter the special transfer belt along with the vibration and will be transferred to the sorting system for sorting.

Preferably, multiple rounds of crushing-sieving cycle control may be set according to the situation of the ores, referring to FIG. 2, the raw ores are subjected to primary crushing and sieving 1, and ores with the granularity less than N1 mm are screened out; and then through intermediate crushing and sieving 2, and ores with the granularity less than N2 mm are screened out.

In the second step, the intelligent sorting system detects each ore, discards the ores with an excessively low grade according to a set standard threshold, and a grade defining parameter is transmitted to a central control system.

The sorting system adopts an X-ray intelligent sorting machine. As shown in FIG. 4, the X-ray intelligent sorting machine is composed of a feeding system, a transmission system, a sensing system, an intelligent identification system and a separation system. The ores screened and graded in the first step are fed by the feeding system into a high-speed belt of the transmission system, are adjusted to a stable state after operating for a certain distance, and are transmitted to the sensing system. When the ores pass under the ray source, the ores are irradiated by X-rays excited by a high voltage, and the ores on the belt will reduce the intensity of the rays, so that the X-rays penetrating the ores are attenuated to different extents due to the content of the measured elements in the ore blocks. A detector below the belt collects attenuation intensity data information and converts the attenuation intensity data information into a photoelectric digital signal to be transmitted to an industrial personal computer of the intelligent identification system. An intelligent sorting software runs in the industrial personal computer, data is subjected to imaging processing and analysis identification, the ore blocks are determined and marked as waste ores or high-grade ores according to a preset sorting parameter, and meanwhile, the marked ore position information is sent to a blowing control unit of the separation system. After the ore blocks fly off the belt of the transmission system, the ore blocks pass through a gas discharge gun of the separation subsystem, and the marked high-grade ores or waste ores are blown accurately through a nozzle of the gas discharge gun, so that the waste ore blocks and the high-grade ores are separated.

In the above sorting process, the intelligent sorting software of the X-ray intelligent sorting machine will transmit the comprehensive grade value and quality of each ore which enters the sorting device within a T time cycle and has a comprehensive grade K less than a threshold TH1 (waste ores) and the comprehensive grade value and quality of each ore with the comprehensive grade higher than the threshold TH1 (ores) to the central control system. The weighted average comprehensive grade of the waste ores within the time cycle is calculated by the central control system, k is a comprehensive grade coefficient of each waste ore calculated by an intelligent sorting model, and m is a quality coefficient of each waste ore calculated by the intelligent sorting model; and the weighted average comprehensive grade of the ores within the time cycle, the weighted comprehensive average grade of the raw ores and the weighted quality of the ores are calculated through the same process, where the comprehensive grade K is calculated by the intelligent sorting model based on an X-ray attenuation signal of each ore.

In the third step, the phosphorus concentrate sorted by the intelligent sorting system enters the ball mill for crushing. In the actual operation, in a case that the granularity of the sorted phosphorus concentrate is still large, the ores can be finely crushed and sieved again and be conveyed to the ball mill for crushing. As shown in FIG. 2, the ores sorted by the intelligent sorting machine may be crushed by the ball mill through the cycle control of fine crushing and sieving 2.

In the fourth step, the fine ores obtained by the ball mill are detected in real time, the detection result is transmitted to the central control system by taking time as a label, and the detected element content is preset by the central control system and may be configured according to the customer requirements. The central control system is a central data processing, storage and state display platform, data of the subsystems is concentrated herein for matching calculation, a communication function of communicating with the subsystems is required, and the abilities of real-time state display, subsystem control and artificial access to a certain extent are achieved.

Preferably, the fine ores are detected by a fluorescence analyzer on line, a plurality of (such as F) mechanical arm positions are arranged on a fine ore belt obtained by the ball mill, the mechanical arms automatically suck a certain number of fine ores according to a predetermined time interval, the sucked fine ores are conveyed to an aggregate position of the fluorescence analyzer through a negative-pressure pipeline, then automatic analysis is performed, the grade of elements specified by the central control system is analyzed, and then the analyzed data is uploaded to the central control system by taking time as a label.

In the fifth step: the central control system accumulates a system time error according to the operation position of the device, the belt transfer state, crushing, sieving statistical time, ball-milling and analysis statistical time, the sorting system uploads the waste ores, the weighted comprehensive average grade related to the phosphorus concentrate and the concentrate powder analysis data acquired by the fluorescence on-line detection system within the range of the matching time error. In a case that the grade of the concentrate powder at a certain time is less than a target grade exceeding error DELTA, the threshold TH1 is increased by taking the error range as the step length function, so that more raw ores with the low comprehensive grade enter the waste ores. The greater the error, the greater the corresponding step length. Through closed-loop feedback, the grade of the concentrate powder is finally within the range of the target grade error DELTA. Otherwise, the threshold TH1 is reduced, and the specific control steps are the same as above.

In the sixth step, the central control system feeds the adjusted threshold TH1 after calculation back to the intelligent sorting system, and the intelligent sorting system adjusts the standard threshold determined as the tailing, so that the grade of the fine ores finally entering a flotation tank is constant. A new threshold TH1′ calculated through central control is sent to the sorting system, and the sorting system performs sorting according to the adjusted threshold TH1.

For example, assuming that an initial standard threshold is set as the threshold TH1, the following situations may occur: taking the phosphorus grade as an example, two phosphate ore production shifts, the average grade values of the phosphate ores entering the sorting machine are K, but in the first shift, the grade of phosphorus entering the concentrate with the comprehensive grade greater than the threshold TH1 is slightly higher than K, the grade of the phosphorus entering the waste ores is slightly lower than K, and the mean value is K. In the second shift, the grade of phosphorus entering the concentrate with the comprehensive grade greater than the threshold TH1 is much higher than K, the grade of the phosphorus entering the waste ores is much lower than K, and the mean value is still K.

In this case, if the standard threshold TH1 of the sorting system is not adjusted, the grade difference of the fine ores after the ores in the two shifts are sorted by the sorting system and enter the flotation tank will be very large, and the flotation effect will be greatly affected.

To avoid this situation, the central control system feeds data information back to the sorting system after receiving the phosphorus grade data information in the first shift fed back by the fluorescence on-line analyzer, the sorting system performs proper adjustment after the standard threshold determined as the tailing is subjected to intelligent analysis, and the grade of the phosphorus subsequently entering flotation can be kept consistent with the grade of the phosphorus entering flotation before. That is, the threshold TH1 is adjusted in real time by taking T as a time interval.

In the seventh step, the fine ores with the stable quality enter the flotation system. According to the method process provided by the present invention, the grades of the fine ores entering the flotation system in different shifts are basically the same, and it is unnecessary to adjust the proportion of chemical reagents of the flotation frequently during flotation, so that the flotation effect can be optimized and the energy consumption can be reduced. According to the present invention, through the central control linkage of the X-ray intelligent sorting machine, the fluorescence on-line analyzer, the X-ray intelligent sorting machine collects attenuation information data of ores under X-rays, cooperates with the fluorescence analyzer to perform real-time grade analysis and feedback, and the attenuation information data and the real-time grade analysis are trained by a self-learning model, so that the intelligent sorting device has a grade prediction ability. According to the present invention, the fine ores entering flotation are monitored by the fluorescence analyzer in real time, and the adjustment of the threshold for determining the ores by an optical sorting machine as waste ores is adjusted at any time, so that the grade of the fine ores is stable.

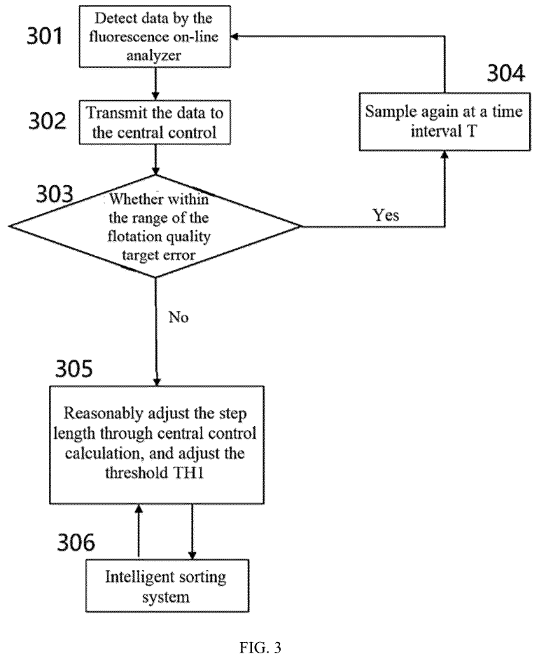

FIG. 3 is a flowchart of a method for dynamically adjusting a threshold according to another embodiment of the present invention.

Step 301: the fine ores obtained by the ball mill are detected by the fluorescence on-line analyzer in real time, and the detection results are marked with time.

Step 302: the detection results marked with time are transmitted to the central control system. The detected element content is preset by the central control system and can be configured according to the customer requirements. The central control system is a central data processing, storage and state display platform. Data of the subsystems is concentrated herein for matching calculation; furthermore, the central control system has a communication function of communicating with the subsystems, and has the functions of real-time state display, subsystem control and artificial access to a certain extent.

In preselection, when the fine ores are detected by the fluorescence on-line analyzer on line or in real time, on the fine ore belt obtained by the ball mill, a plurality of (such as F) mechanical arms are pre-arranged at a plurality of positions, a certain number of fine ores are automatically sucked according to a predetermined time interval, and the sucked fine ores are conveyed to an aggregate position of the fluorescence on-line analyzer through a negative-pressure pipe. Then, the fluorescence on-line analyzer detects the fine ores at the aggregate position to determine the grades of the elements specified or pre-selected by the central control system. Then, the grades of the elements specified or pre-selected by the central control system are marked with time, and the grades of the elements specified or pre-selected by the central control system and marked with time are uploaded to the central control system.

Step 303: the central control system performs calculation according to the grades of the elements specified or pre-selected by the central control system, marked with time and received by the central control system to obtain the current grade of the fine ores, and determines whether the current grade is within the range of flotation quality target review, that is, determines whether the current grade is within the range of the predetermined grade, for example, in a case that the current grade is 27% and the predetermined grade range is greater than or equal to 32%, the current grade is not within the range of the predetermined grade.

In a case that the current grade is within the range of flotation quality target review, that is, it is determined that the current grade is within the range of the predetermined grade, Step 304 is performed to wait for a time interval T, and after the waiting time interval T expires, Step 301 is performed to perform real-time (cyclic) detection on the grade of the fine ores. In a case that it is in the error range, sampling is continued after a certain time interval T. The control of the whole adjustment process is initiated by fluorescence on-line analysis sampling, and T is a relatively long time. Generally, the interval is 20 minutes, 30 minutes or 60 minutes.

In a case that the current grade is not within the range of flotation quality target review, it is determined that the current grade is not within the range of the predetermined grade, and Step 305 is performed.

Step 305: the central control system accumulates a system time error according to the operation position of the device, the belt transfer state, crushing, sieving statistical time, ball-milling and analysis statistical time, the sorting system uploads the waste ores, the weighted comprehensive average grade related to the phosphorus concentrate and the concentrate powder analysis data acquired by the fluorescence on-line detection system within the range of the matching time error. In a case that the grade of the concentrate powder at a certain time is less than the target grade or an exceeding error value of the deviation between the grade of the concentrate powder and the target grade, the exceeding error threshold of the deviation between the grade of the concentrate powder at the current time and the target grade, the threshold TH1 is increased by taking the error range as a step length function, so that more raw ores with low comprehensive grade enter the waste ores. The greater the error, the greater the corresponding step length. Through closed-loop feedback, the grade of the concentrate powder is finally within the range of the target grade error threshold DELTA. Otherwise, the threshold TH1 is reduced, and the specific control steps are the same as above.

In Step 306, the central control system feeds the adjusted threshold TH1 after calculation back to the intelligent sorting system, and the intelligent sorting system adjusts the standard threshold determined as the tailing, so that the grade of the fine ores finally entering a flotation tank is constant. A new threshold TH1′ calculated through central control is sent to the sorting system, and the sorting system performs sorting according to the adjusted threshold TH1.

It should be understood that in the technical solution of the present application, attention should be paid to a time difference at the information matching time. The trigger of time is initiated for completing detection at the time TO through fluorescence on-line detection, the T is the tie of grabbing the ore powder sample, and the detection requires a certain time. Then, ore information uploaded by the intelligent sorting system is required to match the time T0-T1. T1 here is the time required for the ores to move from the intelligent sorting machine to the mechanical arm position of the fluorescence on-line analyzer through the subsequent process and in the form of ore powder. The central control system will calculate the movement step length of TH1 according to the grade error degree, the weighted comprehensive grade of the ores matching the last time and the current threshold TH1 matching the last time.

A step length N=f(x1,x2,x3,x4,x5,x6,x7),

where x 1 is an error (%) of the grade of the main element P and the target grade, x2 is an error (%) of the grade of the element Mg and the target grade, x3 is an error (%) of the grade of the element Al and the target grade, x4 is the weighted comprehensive grade of the concentrate at the time, x5 is the weighted waste ore grade at the time, x6 is the proportion of the quantity of the concentrate, x7 is the adoption of the TH1 value at the time, and x2 and x3 may be input as zero, indicating that the secondary elements are not concerned, x1 is a main parameter and is used with x2 and x3 in an exponential relationship, and x4, x5, x6 and x7 construct a fitting point through a fitting function to map a point obtained through comprehensive calculation of x1, x2 and x3 on the fitting point to finally obtain a step length N.

The formula is used to calculate a variable step length N, the central control returns the calculated and updated TH1+N to the intelligent sorting system, and the threshold setting of the system is changed, so that the system newly adopts TH1=TH1+N. The positive and negative value and the specific value of N are calculated by a function f. Ater the adjustment process is entered, the sampling time T of the fluorescence on-line analyzer will be set as a relatively short time interval, such as 10 minutes. Until the fluorescence analyzer data is within the range of the target error for three consecutive times, the sampling time interval is restored to T. The data of the intelligent sorting machine is always uploaded to the central control in real time, and at the beginning of the whole process, a timestamp of the fluorescence instrument is matched with the data of the intelligent sorting system stored in the central control.

For example, assuming that an initial standard threshold is set as the threshold TH1, the following situations may occur: taking the phosphorus grade as an example, two phosphate ore production shifts, the average grade values of the phosphate ores entering the sorting machine are K, but in the first shift, the grade of phosphorus entering the concentrate with the comprehensive grade greater than the threshold TH1 is slightly higher than K, the grade of the phosphorus entering the waste ores is slightly lower than K, and the mean value is K. In the second shift, the grade of phosphorus entering the concentrate with the comprehensive grade greater than the threshold TH1 is much higher than K, the grade of the phosphorus entering the waste ores is much lower than K, and the mean value is still K. In this case, if the standard threshold TH1 of the sorting system is not adjusted, the grade difference of the fine ores after the ores in the two shifts are sorted by the sorting system and enter the flotation tank will be very large, and the flotation effect will be greatly affected. To avoid this situation, the central control system feeds data information back to the sorting system after receiving the phosphorus grade data information in the first shift fed back by the fluorescence on-line analyzer, the sorting system performs proper adjustment after the standard threshold determined as the tailing is subjected to intelligent analysis, and the grade of the phosphorus subsequently entering flotation can be kept consistent with the grade of the phosphorus entering flotation before. That is, the threshold TH1 is adjusted in real time by taking T as a time interval.

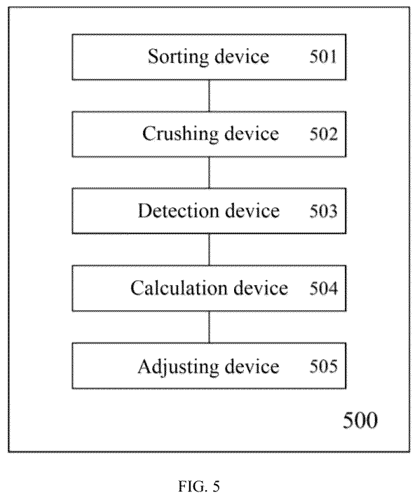

FIG. 5 is a schematic structural diagram of a system 500 for performing intelligent sorting based on dynamic adjustment of a threshold according to an embodiment of the present invention. The system 500 includes: a sorting device 501, a crushing device 502, a detection device 503, a calculation device 504 and an adjusting device 505.

The sorting device 501 is configured to sort ores with a predetermined granularity by an intelligent sorting system according to a current grade threshold to output the sorted ores. Before the ores with a predetermined granularity by an intelligent sorting system are sorted according to a current grade threshold, the system further includes: the to-be-treated original ores are initially treated to obtain the ores with the predetermined granularity, and the ores with the predetermined granularity are transmitted to the intelligent sorting system. The step that the ores with a predetermined granularity are sorted by an intelligent sorting system according to a current grade threshold includes: the comprehensive grade of each are with the predetermined granularity is acquired; the ores with the comprehensive grade less than the current grade threshold are determined as waste ores, and the waste ores are discarded; and the ores with the comprehensive grade equal to or greater than the current grade threshold are determined as the sorted ores.

The step that the to-be-treated original ores are initially treated to obtain the ores with the predetermined granularity includes: multi-level granularity treatment is performed on the to-be-treated original ores to obtain the ores with the predetermined granularity, where each level of granularity treatment in the multi-level granularity treatment includes crushing treatment and sieving treatment, and the granularities of the ores obtained by each level of granularity treatment in the multi-level granularity treatment are sequentially reduced according to the treatment sequence of the granularity treatment from initialization to obtaining the ores with the predetermined granularity.

The step that multi-level granularity treatment is performed on the to-be-treated original ores includes: crushing treatment in a first-level granularity treatment is performed on the to-be-treated original ores, sieving treatment in the first-level granularity treatment is performed on the ores subjected to the crushing treatment, the ores capable of passing the sieving treatment in the first-level granularity treatment are transmitted to the second-level granularity treatment, and crushing treatment in the first-level granularity treatment is continuously performed on the ores capable of not passing the sieving treatment in the first-level granularity treatment until being capable of passing the sieving treatment in the first-level granularity treatment; and according to the treatment sequence of the crushing treatment and the sieving treatment, from the second-level granularity treatment to the last level of granularity treatment of the multi-level granularity treatment, the initial treatment on the to-be-treated original ores is completed to obtain the ores with the predetermined granularity.

The step that ores with a predetermined granularity by an intelligent sorting system are sorted according to a current grade threshold to output the sorted ores includes: the ores with the predetermined granularity are provided by a feeding subsystem to a high-speed belt of a transmission subsystem; after conveying the ores with the predetermined granularity for a predetermined distance, the high-speed belt of the transmission subsystem enters a stable state, and transmits the ores with the predetermined granularity to a sensing subsystem; when the ores with the predetermined granularity are transmitted by the belt to pass through a part under a ray source of the sensing subsystem, the ray source uses X-rays excited by a high voltage to irradiate the ores with the predetermined granularity, where the X-rays penetrating the ores with the predetermined granularity are attenuated to different degrees due to different contents of measured elements; attenuation data information is collected by a detector of the sensing subsystem located below the belt, the attenuation data information is converted into a photoelectric digital signal, and the photoelectric digital signal is transmitted to an intelligent identification subsystem of an intelligent identification system; the intelligent identification subsystem generates a to-be-identified image based on the photoelectric digital signal, performs content identification on the to-be-identified image to determine an ore parameter of the ores with the predetermined granularity, determines a current sorting parameter based on the current grade threshold, compares the ore parameter with the current sorting parameter to mark the ores with the predetermined granularity as waste ores or high-grade ores based on a comparison result, and transmits position information of ores marked as the high-grade ores to a blowing control unit of a separation subsystem; and when the ores with the predetermined granularity are conveyed by the belt of the transmission subsystem to arrive at a predetermined position and a gas discharge gun of the separation subsystem is controlled by the blowing control unit, the ores with the predetermined granularity marked as the high-level ores or the waste ores are blown by a nozzle of the gas discharge gun so as to sort the waste ores and the high-level ores and sort the ores with the predetermined granularity to output the sorted ores.

After content identification is performed on the to-be-identified image to determine an ore parameter of the ores with the predetermined granularity, the system further includes: the ores with the predetermined granularity of which the comprehensive grade is less than the current grade threshold are determined as the waste ores, and the ores with the predetermined granularity of which the comprehensive grade is greater than or equal to the current grade threshold are determined as the high-grade ores; a comprehensive grade value and quality of each waste ore entering the intelligent sorting system within a first predetermined time period are acquired, and a comprehensive grade value and quality of each high-grade ore entering the intelligent sorting system within the first predetermined time period are acquired;
based on the comprehensive grade value and quality of each waste ore, a weighted average grade [symbol] of the waste ores within the first predetermined time period is calculated,
where kfi is a comprehensive grade coefficient of an ith waste ore within the first predetermined time period, mfi is a quality coefficient of the ith waste ore within the first predetermined time period, and nf is a quantity of the waste ores within the first predetermined time period; and
based on the comprehensive grade value and quality of each high-grade ore, a weighted average comprehensive grade [symbol] of the high-grade ores within the first predetermined time period is calculated,
where kyi is a comprehensive grade coefficient of an ith high-grade ore within the first predetermined time period, myi is a quality coefficient of the ith high-grade ore within the first predetermined time period, and ny is a quantity of the waste ores within the first predetermined time period.

The crushing device 502 is configured to crush the sorted ores outputted by the intelligent sorting system to obtain fine ores. The step that the sorted ores outputted by the intelligent sorting system are crushed by the intelligent sorting system includes: the ball mill is used to crush the sorted ores outputted by the intelligent sorting system. The intelligent sorting system is an X-ray intelligent sorting machine.

The step that the sorted ores outputted by the intelligent sorting system are crushed to obtain fine ores includes: the granularity of the sorted ores outputted by the intelligent sorting system is determined: in a case that the granularity is greater than a ball-milling threshold, ores with the granularity greater than the ball-milling threshold are crushed until the granularity is less than or equal to the ball-milling threshold; and in a case that the granularity is less than the ball-milling threshold, the ores with the granularity less than the ball-milling threshold by a ball mill are crushed to obtain the fine ores.

The detection device 503 is configured to perform grade detection on the fine ores to obtain a current state parameter of the fine ores, where the current state parameter includes a current comprehensive grade of the current fine ores. The step that grade detection is performed on the fine ores to obtain a current state parameter of the fine ores includes: within a second predetermined time period, each mechanical arm of a plurality of mechanical arms is used to obtain fine ores with the predetermined quality from the belt conveying the fine ores according to a predetermined time interval; each mechanical arm is promoted to convey the obtained fine ores with the predetermined quality to an aggregate position of a fluorescence analyzer through a negative-pressure pipeline; and when the quality of the fine ores at the aggregate position reaches a quality threshold, the fluorescence analyzer is promoted to perform grade detection on the fine ores to obtain the current state parameter of the fine ores, where the current state parameter includes a current comprehensive grade of the fine ores, a primary element grade of the fine ores, a secondary element grade of the fine ores and a waste ore grade of the fine ores.

The method further includes: a running position of a device in the intelligent sorting system, a belt transfer state, a crushing statistical time, a sieving statistical time, a ball-milling statistical time and an analysis statistical time are accumulated to determine a system delay time; based on the weighted comprehensive average grade related to the waste ores and/or the high-grade ores sorted by the intelligent sorting system within the range of the system delay time and grade analysis data of the fine ores acquired by a fluorescence monitor, a second error rate of a fine ore grade to a target grade at a specific time is determined; in a case that the fine ore grade at the specific time is less than the target grade and the second error rate is greater than a set range of an error rate, a step length function is determined based on the second error rate and a plurality of step lengths are determined through the step length function, and the step length is increased by taking a predetermined time interval as the current grade threshold; and in a case that the fine ore grade at the specific time is greater than the target grade and the second error rate is greater than the set range of the error rate, the step length function is determined based on the second error rate and the plurality of step lengths are determined through the step length function, and the step length is reduced by taking the predetermined time interval as the current grade threshold.

A calculation device 504 is configured to: calculate a first error rate of a current comprehensive grade based on the current comprehensive grade and a target comprehensive grade, and in a case that the first error rate is not within a set range of a comprehensive error rate, calculate a dynamic adjustment step length of a grade threshold according to the current state parameter of the fine ores.

In a case that the first error rate is within a set range of the comprehensive error rate, a third predetermined time period, is waited and Step 101 is performed in a case that the third predetermined time period expires.

The method further includes: a data matching time period is determined, where the data matching time period is, for the same batch of ores with the predetermined granularity, a time difference value between a time T1 when the ores with the predetermined granularity are sorted by the intelligent sorting system according to the current grade threshold and a time T2 when the fine ores are subjected to grade detection to obtain the current state parameter of the fine ores. The step that a dynamic adjustment step length of a grade threshold is calculated according to the current state parameter of the fine ores includes:
a step length N=f(x1,x2,x3,x4,x5,x6,x7),
where x1 is an error of a primary element grade and a primary element target grade, x2 is an error of a first secondary element grade and a first secondary element target grade, x3 is an error of a second secondary element grade and a second secondary element target grade, x4 is the weighted comprehensive grade of the high-grade ores at a current time, x5 is the weighted average comprehensive grade of the waste ores at the current time, x6 is a quantity proportion of the high-grade ores, x7 is the current grade threshold,
x1 is a main parameter and is used with x2 and x3 in an exponential relationship, and x4, x5, x6 and x7 construct a fitting point through a fitting function to map a point obtained through comprehensive calculation of x1, x2 and x3 on the fitting point to finally obtain a step length N.

An adjusting device 505 is configured to perform dynamic adjustment according to the dynamic adjustment step length and the current grade threshold to obtain the adjusted current grade threshold, so that the intelligent sorting system sorts the ores with the predetermined granularity according to the adjusted current grade threshold.

The step that dynamic adjustment is performed according to the dynamic adjustment step length and the current grade threshold to obtain the adjusted current grade threshold, so that the intelligent sorting system sorts the ores with the predetermined granularity according to the adjusted current grade threshold includes: in a case that the current grade threshold is less than the target comprehensive grade, the current grade threshold and the dynamic adjustment step length are added to serve as an adjusted current grade threshold, the adjusted current grade threshold serves as the current grade threshold, and Step 101 is performed: and in a case that the current comprehensive grade is greater than the target comprehensive grade, the dynamic adjustment step length is subtracted from the current grade threshold to serve as an adjusted current grade threshold, the adjusted current grade threshold serves as the current grade threshold, and Step 101 is performed. The step that dynamic adjustment is performed according to the dynamic adjustment step length and the current grade threshold to obtain the adjusted current grade threshold, so that the intelligent sorting system sorts the ores with the predetermined granularity according to the adjusted current grade threshold includes: in a case that the current grade threshold is less than the target comprehensive grade, the current grade threshold and the dynamic adjustment step length are added to serve as an adjusted current grade threshold, the adjusted current grade threshold serves as the current grade threshold, Step 101 is performed, and a fourth predetermined time period is waited after Step 102 is performed; and in a case that the current comprehensive grade is greater than the target comprehensive grade, the dynamic adjustment step length is subtracted from the current grade threshold to serve as an adjusted current grade threshold, the adjusted current grade threshold serves as the current grade threshold, Step 101 is performed, and the fourth predetermined time period is waited after Step 102 is completed, where the fourth predetermined time period is greater than the data matching time period. The intelligent sorting system, the ball mill and the fluorescence on-line analyzer adopt closed-loop control.

According to the disclosure and instruction of the specification, those skilled in the field to which the present invention belongs can change and modify the implementation scheme manners. However, the present invention is not limited to the foregoing specific implementation manner, any modification, replacement, or variation made by a person skilled in the art based on the present invention shall fall within the protection scope of the present invention. In addition, although some specific terms are used in the specification, these terms are only for the convenience of description and do not constitute any limitation to the present invention.

What is claimed is:

1. A method for performing intelligent sorting based on dynamic adjustment of a threshold, the method comprising:
Step 101: sorting ores with a predetermined granularity by an intelligent sorting system according to a current grade threshold to output the sorted ores;
Step 102: crushing the sorted ores outputted by the intelligent sorting system to obtain fine ores;
Step 103: performing grade detection on the fine ores to obtain a current state parameter of the fine ores, wherein the current state parameter comprises a current comprehensive grade of the fine ores;
Step 104: calculating a first error rate of a current comprehensive grade based on the current comprehensive grade and a target comprehensive grade, and in a case that the first error rate is not within a set range of a comprehensive error rate, calculating a dynamic adjustment step length for a grade threshold according to the current state parameter of the fine ores; and
Step 105: performing dynamic adjustment according to the dynamic adjustment step length and the current grade threshold to obtain the adjusted current grade threshold, so that the intelligent sorting system sorts the ores with the predetermined granularity according to the adjusted current grade threshold.

2. The method according to claim 1, wherein
before sorting the ores with a predetermined granularity by an intelligent sorting system according to a current grade threshold, the method further comprises: initially treating the to-be-treated original ores to obtain the ores with the predetermined granularity, and transmitting the ores with the predetermined granularity to the intelligent sorting system.

3. The method according to claim 1, wherein
the sorting ores with a predetermined granularity by an intelligent sorting system according to a current grade threshold comprises: acquiring the comprehensive grade of each ore with the predetermined granularity; determining the ores with the comprehensive grade less than the current grade threshold as waste ores, and discarding the waste ores; and determining the ores with the comprehensive grade equal to or greater than the current grade threshold as the sorted ores.

4. The method according to claim 1, wherein
the crushing the sorted ores outputted by the intelligent sorting system comprises: using a ball mill to crush the sorted ores outputted by the intelligent sorting system.

5. The method according to claim 1, wherein
the intelligent sorting system is an X-ray intelligent sorting machine.

6. The method according to claim 2, wherein
the initially treating the to-be-treated original ores to obtain the ores with the predetermined granularity comprises: performing multi-level granularity treatment on the to-be-treated original ores to obtain the ores with the predetermined granularity, each level of granularity treatment in the multi-level granularity treatment comprising crushing treatment and sieving treatment, and the granularities of the ores obtained by each level of granularity treatment in the multi-level granularity treatment being sequentially reduced according to the treatment sequence of the granularity treatment from initialization to obtaining the ores with the predetermined granularity.

7. The method according to claim 6, wherein
the performing multi-level granularity treatment on the to-be-treated original ores comprises: performing crushing treatment in a first-level granularity treatment on the to-be-treated original ores, performing sieving treatment in the first-level granularity treatment on the ores subjected to the crushing treatment, transmitting the ores capable of passing the sieving treatment in the first-level granularity treatment to the second-level granularity treatment, and continuously performing crushing treatment in the first-level granularity treatment on the ores capable of not passing the sieving treatment in the first-level granularity treatment until being capable of passing the sieving treatment in the first-level granularity treatment; and according to the treatment sequence of the crushing treatment and the sieving treatment, from the second-level granularity treatment to the last level of granularity treatment of the multi-level granularity treatment, completing the initial treatment on the to-be-treated original ores to obtain the ores with the predetermined granularity.

8. The method according to claim 1, wherein
the sorting ores with a predetermined granularity by an intelligent sorting system according to a current grade threshold to output the sorted ores comprises: providing the ores with the predetermined granularity by a feeding subsystem to a high-speed belt of a transmission subsystem; after transmitting the ores with the predetermined granularity by the high-speed belt of the transmission subsystem for a predetermined distance, entering a stable state, and transmitting the ores with the predetermined granularity to a sensing subsystem; when the ores with the predetermined granularity are transmitted by the belt to pass through a part under a ray source of the sensing subsystem, using X-rays excited by a high voltage by the ray source to irradiate the ores with the predetermined granularity, the X-rays penetrating the ores with the predetermined granularity being attenuated to different degrees due to different contents of measured elements: collecting attenuation data information by a detector of the sensing subsystem located below the belt, converting the attenuation data information into a photoelectric digital signal, and transmitting the photoelectric digital signal to an intelligent identification subsystem of an intelligent identification system; generating a to-be-identified image by the intelligent identification subsystem based on the photoelectric digital signal, performing content identification on the to-be-identified image to determine an ore parameter of the ores with the predetermined granularity, determining a current sorting parameter based on the current grade threshold, comparing the ore parameter with the current sorting parameter to mark the ores with the predetermined granularity as waste ores or high-grade ores based on a comparison result, and transmitting position information of ores marked as the high-grade ores to a blowing control unit of a separation subsystem; and when the ores with the predetermined granularity are conveyed by the belt of the transmission subsystem to arrive at a predetermined position and a gas discharge gun of the separation subsystem is controlled by the blowing control unit, blowing the ores with the predetermined granularity marked as the high-level ores or the waste ores by a nozzle of the gas discharge gun so as to sort the waste ores and the high-level ores and sort the ores with the predetermined granularity to output the sorted ores.

9. The method according to claim 8, wherein
after performing the content identification on the to-be-identified image to determine an ore parameter of the ores with the predetermined granularity, the method further comprises: determining the ores with the predetermined granularity of which the comprehensive grade is less than the current grade threshold as the waste ores, and determining the ores with the predetermined granularity of which the comprehensive grade is greater than or equal to the current grade threshold as the high-grade ores; acquiring a comprehensive grade value and quality of each waste ore entering the intelligent sorting system within a first predetermined time period, and acquiring a comprehensive grade value and quality of each high-grade ore entering the intelligent sorting system within the first predetermined time period; based on the comprehensive grade value and quality of each waste ore, calculating a weighted average comprehensive grade
$$\\ Gf = \frac{{\sum }_{i = 1}^{nf} {kf}_{i} \times {mf}_{i}}{nf} ,$$
of the waste ores within the first predetermined time period, kfi being a comprehensive grade coefficient of an ith waste ore within the first predetermined time period, mfi being a quality coefficient of the ith waste ore within the first predetermined time period, and nf being a quantity of the waste ores within the first predetermined time period; and based on the comprehensive grade value and quality of each high-grade ore, calculating a weighted average comprehensive grade
$$\\ Gy = \frac{{\sum }_{i = 1}^{ny} {ky}_{i} \times {my}_{i}}{ny} ,$$
of the high-grade ores within the first predetermined time period, kyi being a comprehensive grade coefficient of an ith high-grade ore within the first predetermined time period, myi being a quality coefficient of the ith high-grade ore within the first predetermined time period, and ny being a quantity of the waste ores within the first predetermined time period.

10. The method according to claim 1, wherein
the crushing the sorted ores outputted by the intelligent sorting system to obtain fine ores comprises: determining the granularity of the sorted ores outputted by the intelligent sorting system; in a case that the granularity is greater than a ball-milling threshold, crushing ores with the granularity greater than the ball-milling threshold until the granularity is less than or equal to the ball-milling threshold; and in a case that the granularity is less than the ball-milling threshold, crushing the ores with the granularity less than the ball-milling threshold by a ball mill to obtain the fine ores.

11. The method according to claim 1, wherein
the performing grade detection on the fine ores to obtain a current state parameter of the fine ores comprises: within a second predetermined time period, using each mechanical arm of a plurality of mechanical arms to obtain fine ores with the predetermined quality from the belt conveying the fine ores according to a predetermined time interval; promoting each mechanical arm to convey the obtained fine ores with the predetermined quality to an aggregate position of a fluorescence analyzer through a negative-pressure pipeline; and when the quality of the fine ores at the aggregate position reaches a quality threshold, promoting the fluorescence analyzer to perform grade detection on the fine ores to obtain the current state parameter of the fine ores, the current state parameter comprising a current comprehensive grade of the fine ores, a primary element grade of the fine ores, a secondary element grade of the fine ores and a waste ore grade of the fine ores.

12. The method according to claim 1, further comprising:
accumulating a running position of a device in the intelligent sorting system, a belt transfer state, a crushing statistical time, a sieving statistical time, a ball-milling statistical time and an analysis statistical time to determine a system delay time; based on the weighted average comprehensive grade related to the waste ores and/or the high-grade ores sorted by the intelligent sorting system within the range of the system delay time and grade analysis data of the fine ores acquired by a fluorescence monitor, determining a second error rate of a fine ore grade to a target grade at a specific time; in a case that the fine ore grade at the specific time is less than the target grade and the second error rate is greater than a set range of an error rate, determining a step length function based on the second error rate and determining a plurality of step lengths through the step length function, and increasing the step length by taking a predetermined time interval as the current grade threshold; and in a case that the fine ore grade at the specific time is greater than the target grade and the second error rate is greater than the set range of the error rate, determining the step length function based on the second error rate and determining the plurality of step lengths through the step length function, and reducing the step length by taking the predetermined time interval as the current grade threshold.

13. The method according to claim 1, wherein
in a case that the first error rate is within a set range of the comprehensive error rate, a third predetermined time period is waited, and Step 101 is performed in a case that the third predetermined time period expires.

14. The method according to claim 1, further comprising:
determining a data matching time period, wherein the data matching time period is, for the same batch of ores with the predetermined granularity, a time difference value between a time T1 when the ores with the predetermined granularity are sorted by the intelligent sorting system according to the current grade threshold and a time T2 when the fine ores are subjected to grade detection to obtain the current state parameter of the fine ores.

15. The method according to claim 1, wherein
the calculating a dynamic adjustment step length for a grade threshold according to the current state parameter of the fine ores comprises: a step length N=f(x1,x2,x3,x4,x5,x6,x7), x1 being an error of a primary element grade and a primary element target grade, x2 being an error of a first secondary element grade and a first secondary element target grade, x3 being an error of a second secondary element grade and a second secondary element target grade, x4 being the weighted comprehensive grade of the high-grade ores at a current time, x5 being the weighted average comprehensive grade of the waste ores at the current time, x6 being a quantity proportion of the high-grade ores, x7 being the current grade threshold, x1 being a main parameter and being used with x2 and x3 in an exponential relationship, and x4, x5, x6 and x7 constructing a fitting point through a fitting function to map a point obtained through comprehensive calculation of x1, x2 and x3 on the fitting point to finally obtain a step length N.

16. The method according to claim 1, wherein
the performing dynamic adjustment according to the dynamic adjustment step length and the current grade threshold to obtain the adjusted current grade threshold, so that the intelligent sorting system sorts the ores with the predetermined granularity according to the adjusted current grade threshold comprises: in a case that the current comprehensive grade is less than the target comprehensive grade, adding the current grade threshold and the dynamic adjustment step length to serve as an adjusted current grade threshold, taking the adjusted current grade threshold as the current grade threshold, and performing Step 101; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, and performing Step 101.

17. The method according to claim 14, wherein
the performing dynamic adjustment according to the dynamic adjustment step length and the current grade threshold to obtain the adjusted current grade threshold, so that the intelligent sorting system sorts the ores with the predetermined granularity according to the adjusted current grade threshold comprises: in a case that the current comprehensive grade is less than the target comprehensive grade, adding the current grade threshold and the dynamic adjustment step length to serve as an adjusted current grade threshold, taking the adjusted current grade threshold as the current grade threshold, performing Step 101, and waiting for a fourth predetermined time period after completing Step 102; and in a case that the current comprehensive grade is greater than the target comprehensive grade, subtracting the dynamic adjustment step length from the current grade threshold to serve as an adjusted current grade threshold, taking the adjusted current grade threshold as the current grade threshold, performing Step 101, and waiting for the fourth predetermined time period after completing Step 102, the fourth predetermined time period being greater than the data matching time period.

18. The method according to claim 8, wherein
the intelligent sorting system, the ball mill and the fluorescence on-line analyzer adopt closed-loop control.
